(19) United States
(12) Patent Application Publication
(10) Pub. No.: US 2009/0289168 A1
(43) Pub. Date: Nov. 26, 2009

(54) Assembly for supporting a jaw crusher frame on a foundation

(76) Inventors: Märten Lindberg, Malmö (SE); Roger Sjobeck, Malmö (SE)

Correspondence Address: DRINKER BIDDLE & REATH (DC), 1500 K STREET, N.W., SUITE 1100, WASHINGTON, DC, 20005-1209, US

(21) Appl. No.: 12/453,733

(22) Filed: May 20, 2009

(30) Foreign Application Priority Data
May 21, 2008 (SE) 0801173-6

(51) Int. Cl. F16M 13/00

(52) U.S. Cl. 248/677

(57) ABSTRACT

An assembly for supporting a jaw crusher frame on a foundation includes a foot adapted to cooperate with the foundation and the frame for supporting the frame on the foundation and a projection connected to the frame and extending substantially horizontally therefrom, the projection having a mainly downwardly facing supporting surface, which has the shape of a part, spanning at least 180°, of a first circular-cylindrical surface. The foot is adapted for attachment to the foundation and has an upwardly open recess, into which the projection is to be lowered and which has a bottom surface, which has the shape of a part, spanning not more than 180°, of a second circular-cylindrical surface and against which the projection, when lowered into the recess, is to abut with its supporting surface. The first and the second circular-cylindrical surface have substantially the same diameter.

### CROSS-REFERENCE TO PRIOR APPLICATION

This application claims priority to Swedish Application No. 0801173-6 filed May 21, 2008, which is incorporated by reference herein.

### FIELD OF THE INVENTION

The present invention relates to an assembly for supporting a jaw crusher frame on a foundation, which assembly includes a foot adapted to cooperate with the foundation and the frame for supporting the frame on the foundation.

### BACKGROUND OF THE INVENTION

A prior-art assembly of this kind will now be described below with reference to FIGS. 1-3, which show, highly schematically, a jaw crusher frame from the side, and FIG. 4, which shows the prior-art assembly in perspective. FIG. 1 shows the frame provided with prior-art assemblies for supporting the same, and FIG. 2 shows the frame without these assemblies. FIG. 3 corresponds to FIG. 1, but shows the frame in a tilted position as compared with the horizontal position shown in FIGS. 1 and 2.

FIG. 1 illustrates schematically one end wall of a jaw crusher frame 1, which end wall is supported by way of two prior-art assemblies 2 on a foundation, which here is in the form of a supporting beam 3, whose upper surface is indicated by a dash-and-dot line in FIGS. 1 and 3. In the same way, the opposite end wall (not shown) of the frame 1 is supported on a foundation in the form of a supporting beam by way of two prior-art assemblies. Thus, the frame 1 is supported, in all, by four identical prior-art assemblies 2.

Each of these four assemblies 2 includes a substantially L-shaped foot, the horizontal leg 2a of which rests on the associated supporting beam 3 and is attached to the same by way of a threaded bolt and the vertical leg 2b of which is attached to the associated frame end wall by way of three threaded bolts. For this purpose the vertical leg 2b has a set of three holes 4 and each frame end wall has a corresponding first set of three holes 4a for each of its two feet. When these two first sets of holes 4a are used to attach the two feet 2 to each frame end wall, the frame 1 is located, with the feet resting on the associated beam 3 (see FIG. 1), in a first position (horizontal position) shown in FIGS. 1 and 2. For the purpose, each frame end wall further has a corresponding second set of three holes 4b for each of its two feet 2. When these two second sets of holes 4b are used to attach the two feet 2 to each frame end wall, the frame 1 is located, with the feet resting on the associated beam 3, in a second position shown in FIG. 3, in which it is tilted approximately 10° to the horizontal position.

Such a tilt may be desirable when a conveyor belt (not shown) disposed under the jaw crusher needs to be inclined so as to be able to transport material crushed by the crusher to a higher level, at which screening of the material, for example, is performed.

During operation, the jaw crusher and, thus, the bolts used to attach the feet 2 to the frame end walls are subjected to considerable stress, which sometimes causes the bolts to break, whereby the feet may come loose. Possibly, this drawback might be eliminated by using heavier bolts. For different reasons, however, it is not possible to form three larger holes in the vertical leg 2b of the L-shaped foot 2 and six (2×3) larger holes in the corresponding portion of the frame end wall concerned. The drawback could also be eliminated by using, for example, five bolts instead of three of the same dimension. To make sure that the frame 1 could still be positioned in two different positions on the foundation 3, this would require forming not less than ten (2×5) holes in each frame end wall for each of its two feet. However, this is not practically feasible for reasons of strength and space.

### SUMMARY

The object of the present invention is therefore to provide an alternative assembly for supporting a jaw crusher frame on a foundation, which assembly makes it possible to eliminate the above-described problem of the bolts breaking during operation of the jaw crusher, while enabling tilting of the crusher to allow, for example, a conveyor belt arranged under the crusher to be inclined for transport of crushed material to a higher level.

This object is achieved by an assembly that includes a projection connected to the frame and extending substantially horizontally therefrom, the projection having a mainly downwardly facing supporting surface, which has the shape of a part, spanning at least 180°, of a first circular-cylindrical surface, and the foot is adapted for attachment to the foundation and has an upwardly open recess, into which the projection is to be lowered and which has a bottom surface, which has the shape of a part, spanning not more than 180°, of a second circular-cylindrical surface and against which the projection, when lowered into the recess, is to abut with its supporting surface, the first and the second circular-cylindrical surface having substantially the same diameter.

Alternatively, the projection may extend from the foundation and the foot may be adapted for attachment to the frame, its recess being open downwards. The above object is achieved also by an assembly that includes a projection connected to the foundation and extending substantially horizontally therefrom, the projection having a mainly upwardly facing supporting surface, which has the shape of a part, spanning at least 180°, of a first circular-cylindrical surface, and the foot is adapted for attachment to the frame and has a downwardly open recess, in which the projection is to be inserted and which has a bottom surface, which has the shape of a part, spanning not more than 180°, of a second circular-cylindrical surface and against which the projection, when inserted into the recess, is to abut with its supporting surface, the first and the second circular-cylindrical surface having substantially the same diameter.

The projection is preferably of circular cross-section.

Preferably, the projection is formed of circular-cylindrical body, which is mounted with a tight fit in a circular countersink, which in the first embodiment is formed in the frame and in the second embodiment is formed in the foundation. The circular-cylindrical body is preferably secured in the countersink by way of a threaded bolt.

Preferably, the bottom surface of the recess is of semi-circular cross-section.

In an assembly according to the first embodiment, the projection may be attached to an adapter plate, which is attached to the frame by way of a plurality of threaded bolts. In this case, the projection is preferably formed of a circular-cylindrical body, which is fixed in a corresponding hole in the adapter plate by welding. In an assembly according the first embodiment, the foot is preferably substantially L-shaped and has a horizontal leg adapted for attachment to the foundation, and a vertical leg, in the upper portion of which the recess is formed.

### BRIEF DESCRIPTION OF THE DRAWINGS

The invention will now be described in more detail with reference to the accompanying drawings.

FIG. 1 and FIG. 2 are side views schematically illustrating the above-described jaw crusher frame in a first position with and without, respectively, prior-art assemblies for supporting the same.

FIG. 3 is a side view corresponding to FIG. 1, but illustrating the jaw crusher frame in a second position.

FIG. 4 is a perspective view illustrating the above-described prior-art assembly.

FIG. 5 and FIG. 6 are side views schematically illustrating a jaw crusher frame provided with assemblies according to the invention and supported on a foundation in two different positions.

FIG. 7 is a perspective view of an assembly according to the invention in cooperation with a jaw crusher frame and a foundation.

FIG. 8 is a perspective view of a foot forming part of the assembly according to FIG. 7.

FIG. 9 is a sectional view of the arrangement shown in FIG. 7.

FIG. 10 is a side view corresponding to FIG. 1 schematically illustrating the jaw crusher frame shown in FIGS. 1-3 in a horizontal position, the prior-art assemblies for supporting the frame having been replaced by adapter plates, which form part of assemblies according to the invention.

FIG. 11 illustrates one of the adapter plates shown in FIG. 10.

### DETAILED DESCRIPTION OF THE PREFERRED EMBODIMENTS

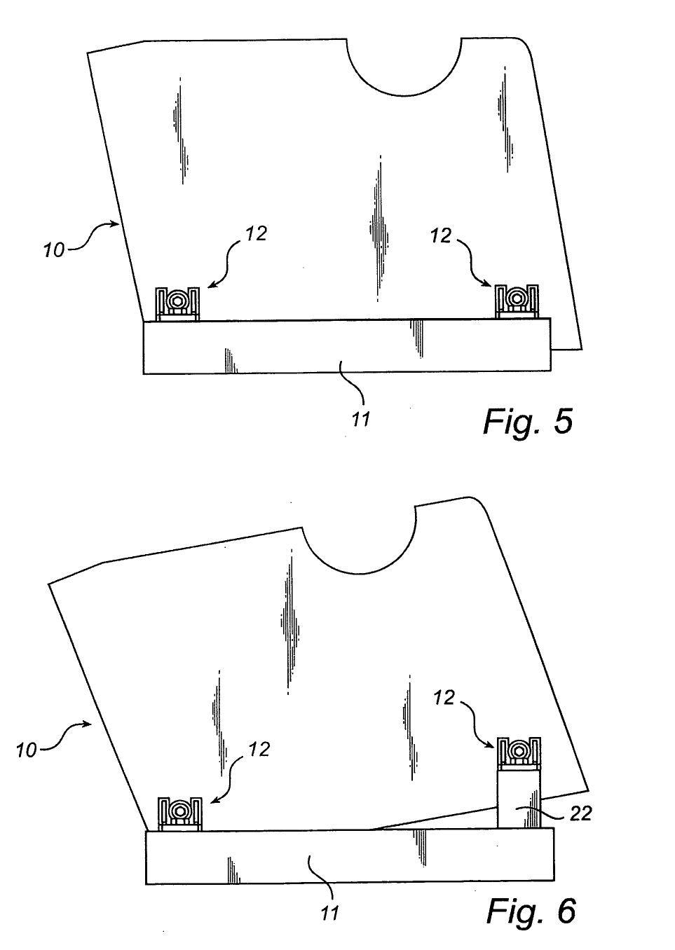

FIG. 5 schematically illustrates one end wall of a jaw crusher frame 10, which end wall, like the opposite end wall of the frame 10, is supported, by way of two assemblies 12 according to the invention, on a foundation, which here is in the form of a hollow supporting beam 11.

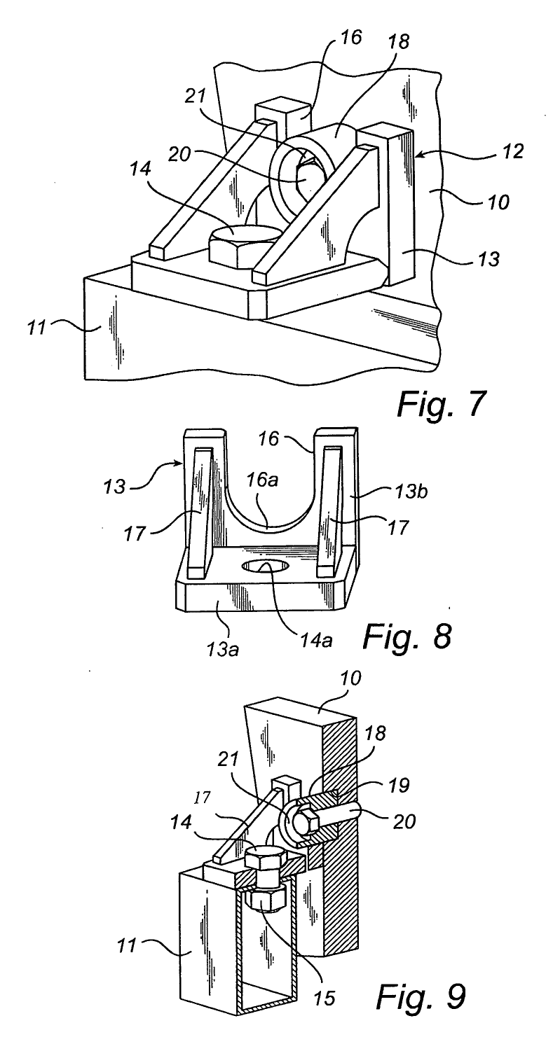

With reference to FIGS. 7-9, the assembly 12 includes a substantially L-shaped foot 13 with a horizontal leg 13a, which is attached to the horizontal, upper wall of the hollow beam 11 by way of a threaded bolt 14, which extends through a bolt hole 14a in the horizontal leg 13a and a corresponding hole in the upper beam wall, and a nut 15 screwed onto the bolt 14. The vertical leg 13b of the L-shaped foot 13 abuts against a plane surface portion of the end wall of the frame 10 and has in its upper portion an upwardly open, substantially U-shaped recess 16 with a bottom surface 16a, which has the shape of a part, spanning not more than 180°, of a circular-cylindrical surface. In the example shown, the bottom surface 16a spans 180° and is thus of semi-circular cross-section and the two side walls defining the recess 16 extend vertically upwards from the ends of the bottom surface 16a over a distance that is slightly greater than half the diameter of the circular-cylindrical surface. The foot 13 further includes two stiffening ribs 17, which extend between the legs 13a and 13b on both sides of the recess 16 in the vertical leg 13b.

The assembly 12 further includes a projection 18, which extends from the vertical end wall of the frame 10 perpendicularly thereto. The projection 18 has a mainly downwardly facing supporting surface, which has the shape of a part, spanning at least 180°, of a circular-cylindrical surface. In the example shown, the projection 18 includes a puck-like, outer portion of a circular-cylindrical steel body, whose inner portion is mounted with a tight fit in a circular countersink 19 in the end wall of the frame 10. The circular-cylindrical body is secured to the end wall by way of a threaded bolt 20, whose head is received in a countersink 21 in the puck-like portion, i.e. the projection 18.

The two circular-cylindrical surfaces mentioned above, i.e. the circular-cylindrical surface defining the bottom surface 16a of the recess 16 and the circular-cylindrical surface defining the supporting surface of the projection 18, have the same diameter.

The projection 18 has been lowered into the recess 16 in the vertical leg 13b of the foot 13 and rests with 180° of its circumferential surface (the supporting surface) on the bottom surface 16a of the recess 16.

The jaw crusher frame 10 is supported on the two supporting beams 11, suspended therefrom, by way of four assemblies 12 in a horizontal position (FIG. 5).

In the case where it is desirable to tilt the frame 10 in the manner shown in FIG. 6 in order to allow a conveyor belt (not shown) disposed under the jaw crusher to be inclined so as to be able to transport material crushed by the crusher to a higher level, it is enough to arrange a supporting block 22 between one assembly 12 (the right one in FIG. 6) and the supporting beam 11 at one frame end wall and an identical supporting block between the opposite assembly 12 and the supporting beam 11 at the other frame end wall. The tilt shown in FIG. 6 is approximately 10°.

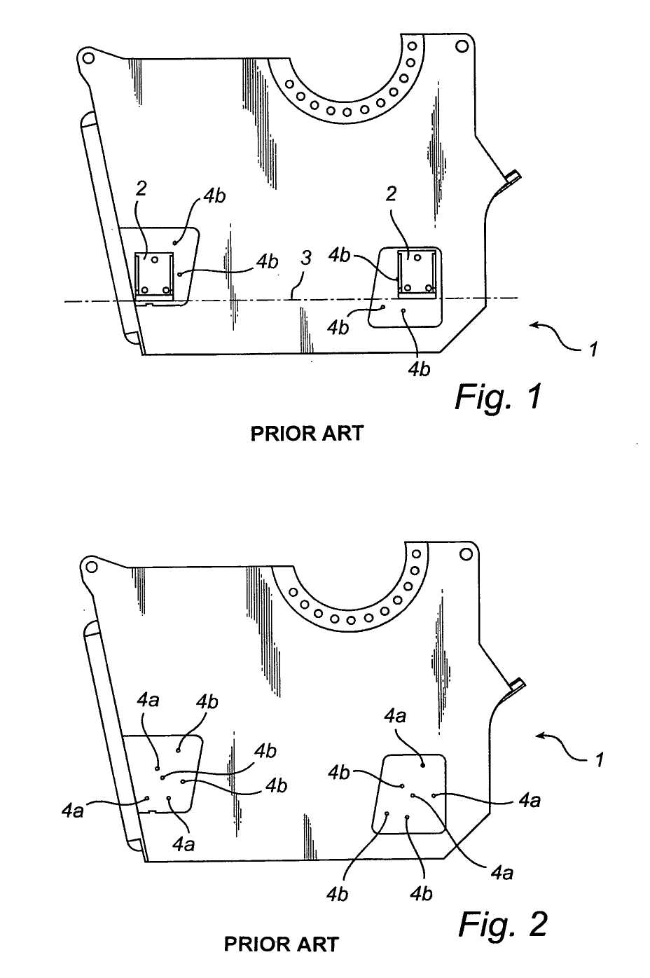

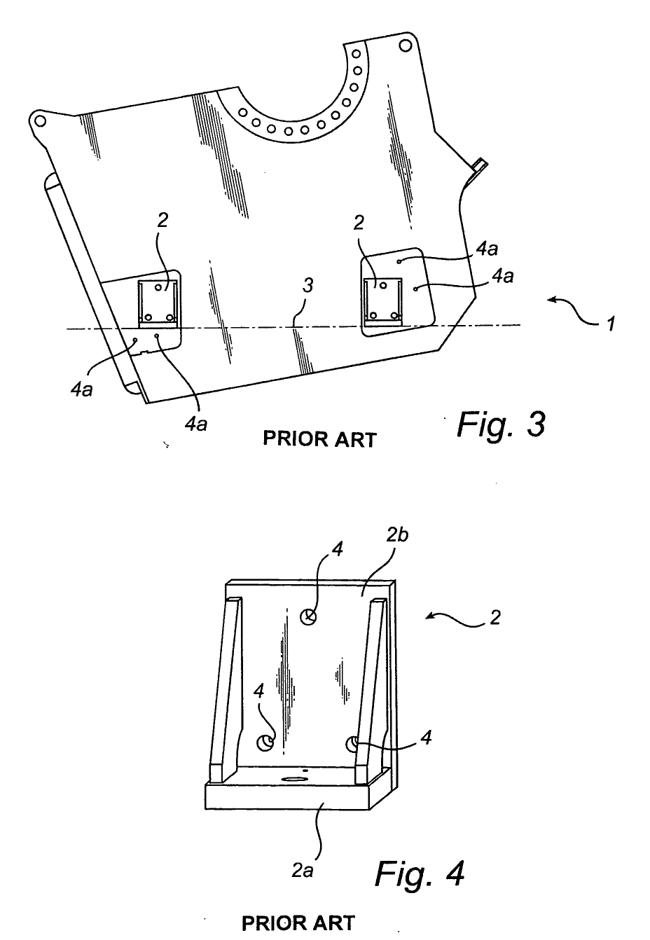

The assembly 12 described above is particularly useful in new jaw crushers, in which from the beginning each of the end walls of the frame 10 is provided with two countersinks 19 for receiving projections 18 and, possibly, also with such projections. In this case, as will be appreciated, there is no need to form hole sets (4a, 4b) of the kind shown in FIGS. 1-3 in the end walls.

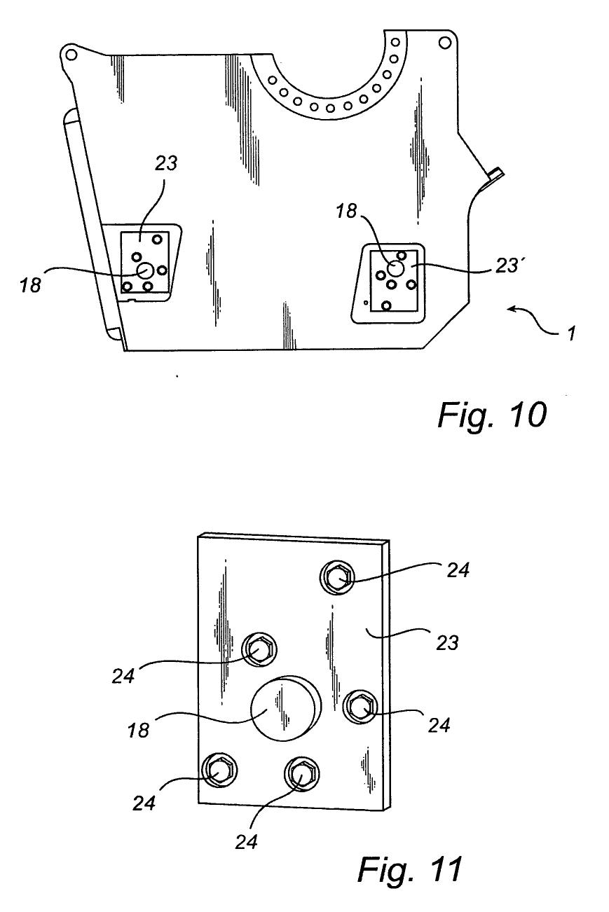

If, however, an assembly according to the invention is to be used in an existing jaw crusher of the kind described by way of introduction with reference to FIGS. 1-3, the projection 18 is attached to an apertured adapter plate 23 or 23′, which is then attached to the frame end wall by way of five threaded bolts 24, which extend through holes in the respective plate and whose heads are countersunk in the respective holes (see FIG. 11). The adapter plate 23 shown to the left in FIG. 10 differs from the adapter plate 23′ shown to the right as regards the location of the projection 18 and the hole configuration of the plate. Each plate 23, 23′ has five holes, which are located such that, when the plate is positioned in its proper position on the frame end wall, they are located just in front of five of the six holes that were intended for the respective L-shaped foot (2) of the jaw crusher frame 1, as described by way of introduction. With the plates 23 and 23′ located in their proper position the projections 18 are horizontally aligned, as shown in FIG. 10.

Also in this case, the projection 18 includes a puck-like outer portion of a circular-cylindrical steel body. This body is mounted in a corresponding hole in the respective plate 23, 23′ and fixed therein by welding.

In an alternative embodiment (not shown), the assembly 12 may be “inverted” in the sense that the projection is connected to the foundation (and not to the frame) and extends therefrom and that the foot is adapted for attachment to the frame (and not to the foundation) and has a downwardly (and not upwardly) facing recess, in which the projection is to be inserted.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. An assembly for supporting a jaw crusher frame on a foundation, comprising:
a foot for cooperating with the foundation;
a projection connected to the frame and extending substantially horizontally therefrom, the projection having a mainly downwardly facing supporting surface, which has the shape of a part, spanning at least 180°, of a first circular-cylindrical surface;
the foot for attachment to the foundation and has an upwardly open recess, into which the projection is to be lowered and which has a bottom surface, which has the shape of a part, spanning not more than 180°, of a second circular-cylindrical surface and against which the projection, when lowered into the recess, is to abut with its supporting surface; and
the first and the second circular-cylindrical surface having substantially the same diameter.

2. The assembly according to claim 1, wherein the projection is of circular cross-section.

3. The assembly according to claim 2, wherein the projection is formed of a circular-cylindrical body, which is mounted with a tight fit in a circular countersink in the frame.

4. The assembly according to claim 3, wherein the circular-cylindrical body is secured in the countersink by way of a threaded bolt.

5. The assembly according to claim 1, wherein the bottom surface of the recess is semi-circular in cross-section.

6. The assembly according to claim 1, wherein the projection is attached to a plate, which is attached to the frame by way of a plurality of threaded bolts.

7. The assembly according to claim 6, wherein the projection is formed of a circular-cylindrical body, which is fixed in a corresponding hole in the plate by welding.

8. The assembly according to claim 1, wherein the foot is substantially L-shaped and has a horizontal leg, which is adapted for attachment to the foundation, and a vertical leg, in the upper portion of which the recess is formed.

9. An assembly for supporting a jaw crusher frame on a foundation, comprising:
a foot for cooperating with the foundation;
a projection connected to the foundation and extending substantially horizontally therefrom, the projection having a mainly upwardly facing supporting surface, which has the shape of a part, spanning at least 180°, of a first circular-cylindrical surface, and
the foot for attachment to the frame and has a downwardly open recess, in which the projection is to be inserted and which has a bottom surface, which has the shape of a part, spanning not more than 180°, of a second circular-cylindrical surface and against which the projection, when inserted into the recess, is to abut with its supporting surface,
the first and the second circular-cylindrical surface having substantially the same diameter.

10. The assembly according to claim 9, wherein the projection is of circular cross-section.

11. The assembly according to claim 10, wherein the projection is formed of a circular-cylindrical body, which is mounted with a tight fit in a circular countersink in the foundation.

12. The assembly according to claim 11, wherein the circular-cylindrical body is secured in the countersink by way of a threaded bolt.

13. The assembly according to claim 9, wherein the bottom surface of the recess is semi-circular in cross-section.
